(19) United States
(12) Patent Application Publication
(10) Pub. No.: US 2014/0129080 A1
(43) Pub. Date: May 8, 2014

(54) SYSTEM AND METHOD FOR RECORDING DRIVING PATTERNS AND SUGGESTING PURCHASABLE VEHICLES

(71) Applicant: RECHARGE SOLUTIONS INT'L, Miami, FL (US)

(72) Inventors: Matthew L. Leibowitz, Miami, FL (US); Michael Cunnyngham, Franklin, TN (US)

(73) Assignee: RECHARGE SOLUTIONS INT'L, Miami, FL (US)

(21) Appl. No.: 13/780,088

(22) Filed: Feb. 28, 2013

Related U.S. Application Data
(60) Provisional application No. 61/604,422, filed on Feb. 28, 2012.

(51) Int. Cl. G06Q 30/06; B60R 16/023

(52) U.S. Cl. CPC G06Q 30/0631; B60R 16/0231
USPC 701/33.3; 705/26.7

(57) ABSTRACT

A system and method are provided for tracking actual driving data using an existing vehicle and providing statistical analyses on whether an electric vehicle or plug-in hybrid vehicle fits the daily driving needs of the user. A mobile device carried by the user in a vehicle is used to collect driving data using sensors of the mobile device. The driving data is compared with file data relating to the attributes of purchasable vehicles to determine purchasable vehicles suited to the driving practices of the individual user, as evidenced by the driving data recorded.

### CROSS-REFERENCE TO RELATED APPLICATIONS

The present application claims priority to co-pending Provisional Patent Application No. 61/604,422, filed on Feb. 28, 2012, entitled “System and Method For Recording Driving Patterns and Suggesting Purchasable Vehicles”; that application being incorporated herein, by reference, in its entirety.

### FIELD OF THE INVENTION

The present disclosure relates generally to systems and methods of recording driving patterns, and more specifically to systems and methods of recording driving patterns and suggesting purchasable vehicles based at least in part on the recorded driving patterns.

### BACKGROUND OF THE INVENTION

Mobile electronic devices such as smartphones have become useful tools for running software applications, communicating, and storing information. Smartphones offer convenient on-the-go computing and wireless connectivity.

Smartphones have built in tools such as the Global Positioning System (“GPS”) to assist in the collection of positioning data for a user.

Electric vehicles and/or plug-in hybrid vehicles provide an immediate solution to critical economic security and economic concerns about the U.S. dependence on foreign oil as well as environmental concerns about increased air pollution.

Auto makers, with assistance from the U.S. government, have embraced the concept of electric vehicles and/or plug-in hybrid vehicles, but consumers have been slower to embrace the adoption of electric vehicles and/or plug-in hybrid vehicles.

A significant obstacle to the development and the sale of electric vehicles and/or plug-in hybrid vehicles in the United States is the limited range associated with electric vehicles and/or plug-in hybrid vehicles and the fear of being stranded on the side of the road with a discharged battery.

Few U.S. citizens consider themselves sufficiently knowledgeable to decide whether or not to purchase an electric vehicle and/or plug-in hybrid vehicle.

Most U.S. citizens overstate their daily driving distances and driving needs.

Most U.S. drivers can use an electric vehicle (EV) or a plug-in hybrid vehicle (PHEV) for their daily driving needs.

Accordingly, there is a need for tools to promote the deployment and widespread adoption of electric vehicles and/or plug-in hybrid vehicles by consumers.

Smartphone applications or “apps” exist that take advantage of internal sensors provided in the smartphone. One such app is the iEV app, described as “The world's first Electric Car Simulator for iPhone”. The iEV app is described as bringing electric vehicles and/or plug-in hybrid vehicles closer to the people, showing that the perceived range problem is not an issue for most drivers and helping users save money when they have to choose which EV to buy. In the IEV app, the users need to press start and begin driving. When the users arrive at the destination, they press stop and the results are presented to them. However, apps that rely on the user to start and stop them suffer from human error. The failure of a user to press the stop button, once started, or the start button before beginning driving, results in the data being skewed, and thus, an erroneous profile being generated. Further, the iEV App relies on the user manually entering preset comparison vehicle data, but does not allow for the App user to input their own existing vehicle (for example, by make and model). The result is that comparison evaluation is substantially less accurate. Additionally, iEV does not collect or provide data on vehicle pollution, potential savings and verifiable data that can be used for a pollution remediation.

What is needed is a system and method that accurately collect actual driving data of a user's existing vehicle from a sensor of the mobile device including, but not limited to, to initiate and terminate the recording of driving data automatically (i.e., without human intervention and, correspondingly, human error). What is additionally needed is a system and method that permits statistical comparison between data relating to a user's own actual vehicle and purchasable electric vehicles and plug-in hybrid vehicles based on the collection of data and generation of statistics, including, but not limited to, information on vehicle pollution, potential savings, verifiable data that can be used for pollution remediation (i.e., carbon trading, reduction of carbon dioxide, methane, etc.).

### SUMMARY OF THE INVENTION

As there is a need for tools to encourage the adoption of electric vehicles and/or plug-in hybrid vehicles by consumers, the present invention provides for systems and methods for recording driving patterns based on a user's existing vehicle and suggesting purchasable vehicles features. For example, one embodiment of the present disclosure includes a mobile device application (for example, a smartphone mobile device application) that utilizes the built-in features of the smartphone (for example, the standard manufacturer-provided features of the smartphone) to record and analyze driving patterns based on a user's existing vehicle to provide convincing evidence to support the purchase of an electric vehicle and/or plug-in hybrid vehicle. In one particular embodiment, the mobile device application can provide information on potential customers to manufacturers of electric and/or plug-in hybrid vehicles and to dealers.

In one embodiment, the presently disclosed systems and methods of recording driving patterns and suggesting purchasable vehicles provide interactive functionality and the ability for potential electric vehicle and/or plug-in hybrid vehicle purchasers to evaluate the applicability of a purchasable vehicle (for example, an electric vehicle and/or plug-in hybrid vehicle) to the potential vehicle purchasers' driving patterns and habits through the use and features of a variety of portable electronic devices, such as portable wireless electronic device, portable global positioning system (GPS) devices, mobile phones, smartphones, or any other electronic device that can be configured to receive and transmit data associated with driving patterns and habits.

The present invention provides an array of features that complement the purchasable vehicle selection processes. For example, locations of fuel or power service stations, pollution-savings data, fuel or power indicators, estimated cost savings, driving range information, and any other information associated with the driver's driving habits or patterns that can affect his or her decision to purchase the purchasable vehicle. In at least one embodiment, the purchasable vehicle selection process can be an electric vehicle and/or plug-in hybrid vehicle selection process. The features for such electric vehicle and/or plug-in hybrid vehicle selection process can include, but are not limited to, locations of charging stations, actual driving habits of users, round-trip and one-way driving range information, pollution and carbon footprint reduction data and battery life indicators.

In one particular embodiment of the present invention, the systems and methods of the present invention can be configured to provide dealers and/or manufacturers of purchasable vehicles targeted information associated with potential customers. Purchasable vehicles can include, but are not limited to, electric vehicles (EVs), plug-in hybrid electric vehicles (PHEVs), gasoline-powered vehicles, diesel-powered vehicles, motorcycles, sports utility vehicles (SUVs), fuel-efficient gasoline-powered vehicles (for example, Smart™ cars, Mini™ cars, or other fuel-efficient gasoline-powered vehicles), hydrogen-powered vehicles, fuel cell vehicles, or any other vehicle which can be purchased and compared to the current vehicle of customers.

The present invention provides for a mobile device application that can demonstrate to individual users who are prospective buyers of purchasable vehicles whether or not the driver can benefit from purchasing a purchasable vehicle based on the driver's actual habits. For example, in one particular embodiment of the invention, the mobile device application can demonstrate to individual users who are prospective buyers of purchasable vehicles that are electric vehicles, and/or plug-in hybrid vehicles that based on an individual's actual driving habits using their own existing vehicle, a large percentage of U.S. drivers can use an EV or PHEV.

The presently disclosed systems and methods of recording driving patterns and suggesting purchasable vehicles can utilize at least one of the functions and/or components of the mobile device such as a mobile computing system of the mobile device, Bluetooth™ connection, a portable media player, a compact digital camera, a video camera, a GPS navigation, a touchscreen, a web browser that can access and display web pages, a high-speed data access via Wi-Fi and mobile broadband, or any other function and/or component of the mobile device.

The mobile device application can integrate with the mobile device's operating system and hardware through advanced mobile device application programming interfaces (API's).

In one particular embodiment of the invention, when the mobile device application is initiated, data regarding the EV/PHEV vehicles, dealers, and manufacturers can be downloaded on the mobile device from one or more mobile device application servers communicatively coupled to the mobile device.

When the mobile device application is initiated, user data collected while the mobile device application is offline can be uploaded to the mobile device application servers to ensure integrity and accuracy of the data used in subsequent data analysis. Additionally, user data collected while the mobile device application is online can be uploaded to the mobile device application server.

The driving data collected by the mobile device application can be analyzed using analysis tools (for example, the processor of the mobile device, a processor communicatively coupled to the mobile device, one or more processors coupled to the mobile device application server, or any other processor or processing system communicatively coupled to the mobile device) developed for the mobile device application. The recommendations resulting from the analyzed driver data can be downloaded to, or generated in, the smartphone.

In at least one embodiment, a system and method for recording driving patterns and suggesting purchasable vehicles features can be implemented on a Windows™ PC platform and/or for Mac™ OS and Linux™ platforms, or any other suitable platform.

In at least one embodiment of the present invention wherein the systems and methods for recording driving patterns and suggesting purchasable vehicles features are implemented as a mobile device, mobile device application can be downloaded for free or for a nominal fee through the Apple™ App store, the Android™ market, or any other source of mobile device application.

In such an embodiment, the user can log in to the mobile device application via a graphical user interface (GUI) to create a profile. The profile can include an address for a user, such as the user's email address, zip code, and basic data about the user's current vehicle. For example, the basic data about the user's current vehicle can include the make, model and year of the vehicle which allows for the mobile device application to use accurate information regarding the performance of that vehicle for comparison and evaluation purposes. The user profile can also allow the default cost of gasoline and the default cost of electricity to be manually overridden at the user's option.

In at least one embodiment, the mobile device application can operate automatically in the background of the mobile device (for example, a Smartphone) and does not require any additional input.

In a further embodiment of the invention, the mobile device application can be initiated when the driver starts a trip and can be concluded when the driver ends a trip without user input. That is, in the present particular embodiment of the invention, the driving pattern tracking is initiated automatically. In one particular embodiment of the invention, if the accelerometer of the mobile device determines that a vehicle has begun moving (for example, by detecting movement that matches or exceeds a predetermined value without user intervention), the mobile device application can begin tracking driving pattern data. If, in this embodiment, the accelerometer of the mobile device determines that a vehicle has stopped moving (for example, by detecting absence of movement for a pre-determined length of time), the mobile device application can automatically (without user intervention) stop tracking driving pattern data. The mobile device can also eliminate non vehicle information in its tracking (i.e., walking, plane, etc.).

The system and method for recording driving patterns and suggesting purchasable vehicles features, in accordance with particular embodiments of the invention, can utilize the tool and/or components of the mobile device to determine the driving patterns of the user. For example, such tools and/or components provided as part of the mobile device and utilized by the system of the invention can include, but are not limited to, a Global Positioning System (“GPS”), an accelerometer, a barometer, a Bluetooth™ connection, or any other component configured to detect (or interfacing with a component configured to detect) the conditions of real world driving by the user on a predetermined basis (for example, a daily basis, a semi-daily basis, workdays, weekends, or any other predetermined basis). The conditions detected can be recorded as driving pattern data. Based on the driving pattern data, the driving pattern of the user can be determined.

In at least one embodiment of the invention, the system and method for recording driving patterns and suggesting purchasable vehicles features can include one or more databases or database system containing automotive performance data associated with the performance of purchasable vehicles. The driving pattern data can be combined with automotive performance data collected or retrieved from one or more databases, including automotive performance data, to develop an analytical snapshot of the individual's driving patterns. The user's existing driving patterns for an existing vehicle (for example, for a gasoline vehicle, an already-purchased vehicle, an already-purchased electric vehicle and/or plug-in hybrid vehicle, etc.) are compared with actual and estimated purchasable vehicles (for example, purchasable EVs and PHEVs) to demonstrate whether the user will likely be able to drive a purchasable vehicle to meet their existing driving patterns. The automotive performance data can also be retrieved from other sources, for example, from one or more websites of purchasable vehicle manufacturers, from a third-party's database system, one or more websites of purchasable vehicle dealers, one or more database systems of a purchasable vehicle dealer, an automotive-vehicle-review website, a crowd-sourced database having performance review of automotive vehicles or any other source from which automotive performance data associated with purchasable vehicles can be retrieved.

The systems and methods for recording driving patterns and suggesting purchasable vehicles features disclosed herein are not only informative but are also engaging, as the disclosed systems and method encourages users to interact with the system daily, share their experiences with others via social media, and for gaming (i.e., who saved most gas today?).

In accordance with one particular embodiment of the invention, at any time, the user can look at the graphical user interface (GUI) of the mobile device application to determine his or her current location, and see range information at a glance. For example, a range can be a distance in which the driver has sufficient power (for example, battery power or fuel power) to reach a destination if the driver were driving the purchasable vehicle. In one example, where the purchasable vehicle is an electric vehicle and/or plug-in hybrid vehicle, the GUI for the system can provide a green circle, or any other indicator, that defines the area within which the user will have sufficient battery power to get home without recharging. A blue circle, or any other indicator, can be provided to indicate the furthest one way trip the user can take given the existing battery power without recharging.

In another embodiment, the driver can select a location on a map displayed on the GUI, and a first circle and/or a second circle, for example, a green circle and a blue circle, respectively, can be provided on the display to indicate whether the user would have sufficient power to arrive at the selected location without requiring a refueling or recharging if the driver were driving the purchasable vehicle. Those of ordinary skill in the art will appreciate that other differentiators can be implemented to distinguish between the various ranges and driving range information associated with purchasable vehicle based at least in part on the driver's driving data corresponding to the driving habits and patterns of the driver's current or existing vehicle.

In one particular embodiment, a user interface for the system can provide a map having charging locations to provide additional comfort for the user to overcome range anxiety. If desired, the user interface can include additional details about the charging locations. In one embodiment, such additional details about their locations are made available by charger vendors and/or operators for a fee.

In one embodiment, users can view, via the GUI and on a real time or substantially real time basis, a comparison of the user's driving habits with similar simulated driving habits simulated for a purchasable vehicle. For example, where the user's current vehicle is a gasoline-powered vehicle, and the purchasable vehicle is a EV or PHEV, the GUI can display a comparison of the driving patterns of the user's gasoline-powered vehicles versus a EV or PHEV that has been driven under the user's same driving patterns for the user's gasoline-powered vehicle. With such a comparison, the user can estimate whether a EV or PHEV will meet their daily driving mileage requirements.

The systems and methods for recording driving patterns and suggesting purchasable vehicles features disclosed herein, based on published data and a data analysis methodology, can estimate how much money a user can save by driving an electric vehicle, a plug-in-electric vehicle, a diesel-powered vehicle, a hydrogen-powered vehicle, or any other purchasable vehicle.

In addition, the systems and methods for recording driving patterns and suggesting purchasable vehicles features disclosed herein, based on published data and a data analysis, can estimate in a reliable and verifiable manner the amount of pollution that can be eliminated by driving an purchasable vehicle, and its location (for example, an EV or PHEV). In another embodiment, pollution savings or carbon credits can be aggregated for the purpose of monetizing these savings for the App user, the manufacturer and/or service or app providers such as, but not limited to, trading in the carbon trading markets.

The systems and methods for recording driving patterns and suggesting purchasable vehicles features of the present invention can also include a method for calibrating the mobile device application's virtual battery level indicator with the actual level of the purchasable vehicle's battery or fuel supply (for example, an EV's battery). Thus, the user can manually adjust the virtual battery level indicator to match the real battery level of their EV. The calibration differences can be aggregated on mobile device application servers, and median offsets can be used to reformulate calculations. All deployed mobile device applications could then be updated with the new formula.

In at least one embodiment of the present invention, the systems and methods for recording driving patterns and suggesting purchasable vehicles features disclosed herein can provide information on a predictive degradation of range through battery depletion based on one or more of the following: actual temperature, forecasted temperature, historical usage of the vehicle's climate control system for the individual driver, and/or any other data which allows for a predictive degradation of range. If desired, a system and method for recording driving patterns and suggesting purchasable vehicles features in accordance with the invention can also provide available data on other drivers using the same model of purchasable vehicle (for example, a similar EV model) on the same trip (or even partial legs of the same trip).

The system and method for recording driving patterns and suggesting purchasable vehicles of one particular embodiment of the present invention can provide a warning of range degradation when the vehicle reaches certain speeds or experiences other environment factors (for example, rain, wind, humidity, temperature, air pressure, ozone measurement, or any other environmental factors that can affect driving patterns and fuel usage) that increase the drain on the battery or fuel supply of the purchasable vehicle that exceed the original range calculations. Additionally, in one embodiment of the present invention, the system and method can provide a score keeping feature that allows purchasable vehicle drivers (and virtual purchasable vehicle evaluators) to opt-in to a high score keeping system that lets them rank their achievements. For example, where the purchasable vehicle drivers are EV drivers, the feature can allow the EV drivers to rank achievements, such as longest trip on a single charge, least amount of carbon output, lowest average cost per mile, etc. This feature allows for competitive gaming between drivers. These achievements can be shared on social networks such as Twitter™, Facebook™, and Google+™ or any other social network.

In at least one particular embodiment of the invention, after the driving habit analysis, the user can be queried (for example, via the GUI of the mobile device application) as to whether the user would be interested in purchasing the purchasable vehicle within predetermined time frames (for example, within one week, one month, etc.) as well as the price range considered for a purchase or lease, and the body type and style the user prefers (for example, SUV, coupe, sedan, sports car, or any other preferred vehicle).

In at least one particular embodiment of the invention, the mobile App can analyze the driver's existing driving habits and make specific recommendation of vehicles that would meet the driver's needs.

If the user is interested in purchasing the purchasable vehicle, a prompt can be presented to the user that includes user-selectable additional information associated with purchasing the purchasable vehicle. For example, the prompt can include a list of current available purchasable vehicles with general specifications, as published by the automotive manufacturers. Additionally, the participating manufacturer can provide written, video and photo information on its [electric] vehicle and/or plug-in hybrid vehicle, including purchase options, loans and leasing. Participating manufacturers or dealers as used herein, include, but are not limited to, a manufacturer or dealer who has entered into an agreement with the proprietor of the systems and methods for recording driving patterns and suggesting purchasable vehicles.

In another embodiment, if the user indicates an interest in purchasing a purchasable vehicle within a set time period (e.g., within three months), the user can be provided with a GUI having one or more participating dealers be able to click through to see which participating dealers are located within a specific radius of the user's location, and/or the manufacturer.

The user can then choose one or more participating local purchasable vehicle dealers near them who sell the desired make and model of the vehicle. In response to the selection of the one or more participating local purchasable vehicle dealers, the participating dealer(s) and/or manufacturers corresponding to the user's selection can receive an email, text message, automated voicemail, or any other message with relevant user information so that the participating dealer(s) can contact prospective buyer. In another embodiment, the user can make a mobile device appointment via the mobile device (for example, the smartphone). In a further embodiment, the user can be immediately connected to the participating dealer by voice or video.

The systems and methods for recording driving patterns and suggesting purchasable vehicles disclosed herein allows for purchasable vehicle manufacturers to provide specific information regarding the purchasable vehicle manufacturers' purchasable vehicle, in written and/or photo form via the GUI of the mobile device application. In at least one embodiment, the purchasable vehicle manufacturer can provide such information for a fee. In another embodiment, the GUI of the mobile device application can include a video tour of the purchasable vehicle.

In still another embodiment, participating manufacturers can access data regarding users with specific demonstrated interest in the participating manufacturers' vehicle(s), as well as, demonstrated interest in the participating manufacturers' competitors, both nationally and/or within a defined geographic area. Such access to data can be provided to the participating manufacturers for a fee.

In a further embodiment, participating manufacturers can monitor the effectiveness of the participating dealers' sales efforts. Such monitoring can be provided to the participating manufacturers for a fee.

The systems and methods for recording driving patterns and suggesting purchasable vehicles disclosed herein can also allow participating dealers the option to be included on the mobile device application's maps, and to be able to provide specific information in the mobile device application for users, such as their street address, hours of operations, or other information associated with the participating dealer. In another embodiment, the specific identity, contact information and actual driving information for a prospective purchaser can be delivered in real time from the mobile device application to the participating dealer. If desired, the participating dealers can also participate in instant audio and/or video connections, via the mobile device application, with prospective purchasers that already have expressed interest in a vehicle or vehicles. Such instant communication can be provided to the participating dealer(s) for a fee.

The systems and methods for recording driving patterns and suggesting purchasable vehicles disclosed herein can also provide fuel providers, gas stations, hydrogen stations, EV charger manufacturers, dealers, EV charging providers and EV infrastructure companies with potential user information for a fee. Also, the locations of the EV charging providers and EV infrastructure companies can be provided on a map displayed in the GUI for a fee. In another embodiment, information regarding the EV charging providers and EV infrastructure companies' services or a link to their web sites to display their products can also be included in the GUI of the mobile device application, for a fee.

The systems and methods for recording driving patterns and suggesting purchasable vehicles disclosed herein can also be provided to utility companies (for example, for a fee). This collection of driving pattern data can provide data associated with prospective electric vehicle and/or plug-in hybrid vehicle usage to plan future upgrades of the utility provider's grids, and to evaluate the need for smart grid features for charging, such as peak and off-peak pricing. Additionally, if desired, the system and method of the invention can provide information, for a fee, to Federal, state and/or local governments, for example, for urban planning, such as planning of parking spaces and greenhouse gas and pollution control.

If desired, the systems and methods for recording driving patterns and suggesting purchasable vehicles disclosed herein can also be provided to research companies, for example, for a fee.

With the systems and methods for recording driving patterns and suggesting purchasable vehicles disclosed herein, the GUI can include maps with driving distances and charging station locations, and can include indicators that monitor battery usage and provide estimates of the remaining life of the user's battery or fuel power.

In another particular embodiment of the invention, systems and methods for recording driving patterns and suggesting purchasable vehicles that are disclosed herein can include one or more user-selectable options associated with after-market product or services. For example, if the user's current vehicle is an EV or if the purchasable vehicle is an EV, the user-selectable options can be associated with jumper cables to provide roadside charging, participating electric vehicle and/or plug-in hybrid vehicle charging locations and service centers.

In yet another embodiment, the systems and methods for recording driving patterns and suggesting purchasable vehicles disclosed herein can also be communicatively coupled to computing systems associated with roadside assistance services. For example, the American Automobile Association (“AAA”) and other servicing agencies.

The systems and methods for recording driving patterns and suggesting purchasable vehicles disclosed herein can also be provided to electric charging station manufacturers and dealers, fuel service manufacturers and dealers, or any other vehicle power manufacturer or dealer, for a fee.

The systems and methods for recording driving patterns and suggesting purchasable vehicles disclosed herein can also, optionally, be customized to include the languages of the country in which the mobile device application is used, and the maps (including, actual dealer locations) associated with the country in which the mobile device application is used. For example, the mobile device application can provide the user with the option of setting, or can default to, different metrics, based on location, such as adapting the information to display as gallons v. liters and in different currencies.

The systems and methods for recording driving patterns and suggesting purchasable vehicles disclosed herein can also be utilized by fleet operators. The fleet operators can gather driving pattern data for their existing fleets on which to base their electric vehicle and/or plug-in hybrid vehicle purchasing decisions.

### BRIEF DESCRIPTION OF THE DRAWINGS

FIG. 1 is a simplified schematic diagram illustrating components of a system for recording driving patterns and suggesting purchasable vehicles in accordance with one exemplary embodiment of the present invention;

FIGS. 2-7 and 10 are screen shots of exemplary start-up and registration or enrollment screens in accordance with one particular embodiment of the present invention.

FIGS. 8-9 and 11 are screen shots of exemplary information gathering or data input screens with fillable GUI forms executable by a user in accordance with one particular embodiment of the invention.

FIGS. 12 and 13 are screen shots illustrating a data gathering feature in accordance with one particular embodiment of the invention.

FIG. 14 is a screen shot illustrating a range feature in accordance with one particular embodiment of the present invention.

FIGS. 15-16 are screen shots illustrating a places or my places feature in accordance with one particular embodiment of the present invention.

FIGS. 17-19 are screen shots illustrating statistics provided in accordance with one particular embodiment of the present invention.

FIGS. 20-21 are screen shots illustrating settings features available in accordance with one particular embodiment of the present invention.

FIGS. 22-24 are screen shots illustrating a feature in which recommendations are made to the user based on the statistics gathered in accordance with one particular embodiment of the present invention.

FIGS. 25-26 are screen shots of fillable GUI forms executable by a user to send an inquiry and/or information relating to the user's interest in purchasing a vehicle in accordance with one particular embodiment of the present invention.

### DETAILED DESCRIPTION OF THE INVENTION

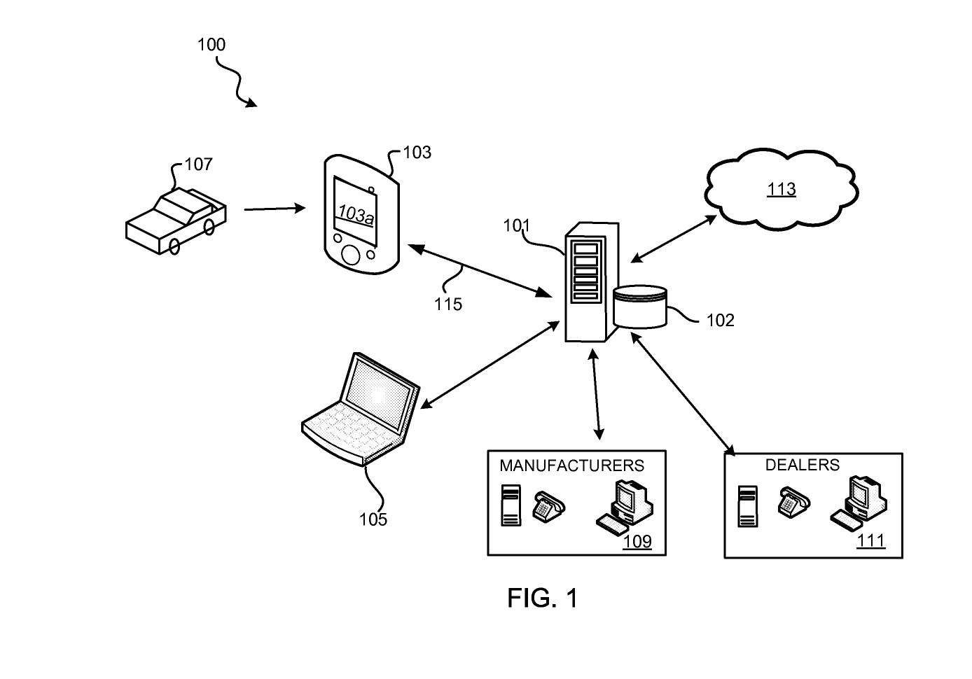

Referring now to FIGS. 1-26, there will be described a preferred embodiment of a system and method for recording driving patterns and suggesting purchasable vehicles that provide interactive functionality, in accordance with the present invention. More particularly, the system 100 will enable a potential purchasable vehicle purchaser (for example, electric vehicle and/or plug-in hybrid vehicle purchasers) to evaluate the suitability of a purchasable vehicle (for example, EVs), as applied to that particular potential purchaser's individual driving patterns and habits through the use and features of a mobile device 103, 105 (for example, a smartphone 103).

The mobile device 103, 105 includes a processor for executing instructions saved in a non-transitory memory of the mobile device 103, 105. For example, in accordance with the present invention, an application program can be downloaded, or otherwise stored, to memory of the mobile device 103, 105 and executed to record driving patterns and suggest purchasable vehicles to the user, based on the recorded driving patterns. Such a mobile device application can include additional features that complement the electric vehicle and/or plug-in hybrid vehicle selection process, including, but not limited to, providing: the locations of charging stations; the locations of fuel or power providers; round-trip and one-way driving range information; pollution and carbon footprint reduction data; and/or battery life indicators.

If desired, an application operating on the mobile device 103, 105 can also be used to get targeted information on or to potential customers from vehicle dealers and/or manufacturers of purchasable vehicles (for example, electric vehicle (EV) and plug-in hybrid electric vehicle (PHEV) car dealers/manufacturers). The mobile device 103, 105 can be any type of mobile device that can travel with the user in a vehicle 107 and determine, from those travels, data relating to the driving patterns of the user carrying the mobile device 103, 105. In other words, although depicted as a smartphone 103 and laptop 105, this is not meant to be limiting, as other types of mobile device, including PDA's, iPods, tablets, programmable GPS navigational device, etc., can be used without departing from the scope of the present invention. In one particularly preferred embodiment, the mobile device 103 is an iPHONE™ produced by Apple Inc. or an Android™ device.

Referring more particularly to FIG. 1, the system 100 of the present preferred embodiment includes a mobile device application server 101 communicatively coupled to at least one mobile device 103, 105 by a communications network, which, in the present preferred embodiment, is wireless. The mobile device application server 101 can include one or more servers and/or computing systems arranged at one or more locations in the system 100. The mobile device application server 101 can access data stored in a database 102 stored on non-transitory computer-readable storage media, that relates to the driving pattern data collected from a mobile device 103, 105 while carried in a vehicle 107.

The mobile device application server 101 is coupled to the smartphone 103, via a communication network such as a telecommunications network, a wireless network, a Bluetooth™ connection, a Wi-Fi network, a near-field communication interface, or any other network by which the smartphone 103 (or mobile device) can transmit and receive information and data from the mobile device application server 101. The smartphone 103 can be located within a vehicle 107 in order to record and detect driving pattern data of the user.

As noted above, the mobile device 103, 105 can include a mobile phone, a smartphone 103, a personal computer 105, a tablet computer, programmable GPS navigation device or any other mobile device that can be carried by a user and with which driving pattern data can be detected. Mobile device 103, 105 can include a plurality of sensors, including, but not limited to, a global position system (GPS) sensor, a barometer, an accelerometer, a camera, a thermometer, Bluetooth™ connection, and/or any other sensor that can detect environmental characteristics of the environment in which the mobile device is located. The sensor can also include any sensor that can detect driving data corresponding to a vehicle 107 in which the mobile device 103, 105 is located. For example, the driving data detected can include a speed of the car, a distance traveled by the car, a travel time, a climate control usage of the vehicle, or any other data which can be gathered by the sensors of the mobile device 103, 105 to record driving data used to determine driving patterns associated with the vehicle 107. As is well known, certain smartphones 103, such as the iPHONE™ and certain Android™ smartphones, already include GPS sensors and accelerometers that can be used to determine driving data for the vehicle 107 in which the mobile device 103, 105 is carried.

Additionally, in one particularly preferred embodiment of the invention, the mobile device 103, 105 is a smartphone 103 having a touchscreen display 103a. The touchscreen display 103a can be a light emitting diode (LED) display, a liquid crystal display (LCD), a digital light processing (DLP) display, a nanocrystal display, an organic light emitting diode (OLED) display, an active matrix organic light emitting diode (AMOLED) display, or any other display which an display graphical information and can act as a user input interface by which user inputs can be entered.

Referring back to FIG. 1, the system 100 can include a manufacturers' interface 109 including a computing system, computer-readable medium system, and/or other processing system storing a database related to the manufacturers and their associated purchasable vehicles. The manufacturer's interface 109 can provide the interface by which the mobile device application server 101 retrieves data associated with purchasable vehicle(s) to which the driving patterns captured and recorded by the mobile device 103, 105 are compared. The mobile device application server 101 can also transmit the mobile device user's driving pattern data to the manufacturers of purchasable vehicles via the manufacturers' interface 109.

In one embodiment, the system 100 also includes a dealers' interface 111. The dealers' interface 111 can include a computing system, computer-readable medium system, and/or other processing system storing a database related to the dealer's purchasable vehicles. The dealers' interface 111 can provide the interface by which the mobile device application server 101 retrieves data associated with purchasable vehicles to which the mobile device user's driving patterns are compared. The mobile device application server 101 can also transmit the mobile device user's driving pattern data to the dealers of purchasable vehicles via the dealers' interface 111.

The system 100 can also include an interface for communicating with other networks, such as the Internet 113. The communications interface can be an Internet interface, a network-based interface, a peer-to-peer device interface, or any other communication interface. In FIG. 1, the communications interface is an internet interface that can couple the mobile device application server 101 to one or more Internet websites associated with one or more of: purchasable vehicle manufacturers, purchasable vehicle dealers, gasoline-powered vehicle manufacturers, gasoline-powered vehicle dealers, hydrogen-powered vehicle dealers, EV and/or PHEV manufacturers, EV and/or PHEV dealers, consumer reporting websites, automotive websites, vehicle-review websites, or any other websites that include information associated with purchasable vehicles. The mobile device application server 101 can retrieve data associated with the purchasable vehicles to which the mobile device user's driving patterns will be compared from such websites via the Internet interface on the Internet 113.

The mobile device application executed on the mobile device 103, 105, in accordance with one particular embodiment, can utilize a persistent network connection 115. If the mobile device application loses the network connection (i.e., to the Internet 113 and/or to the mobile device application server 101), GPS data can continue to update and be logged in the mobile device 103, 105, itself. However, the maps and other environmental features can be unavailable until network connectivity is restored. The mobile device application can also utilize enabled location services associated with the mobile device 103, 105. If the user has disabled the location services, the mobile device application can request the user to enable the location services, for example, by requesting the user to enable the location services in the system settings of the mobile device 103, 105.

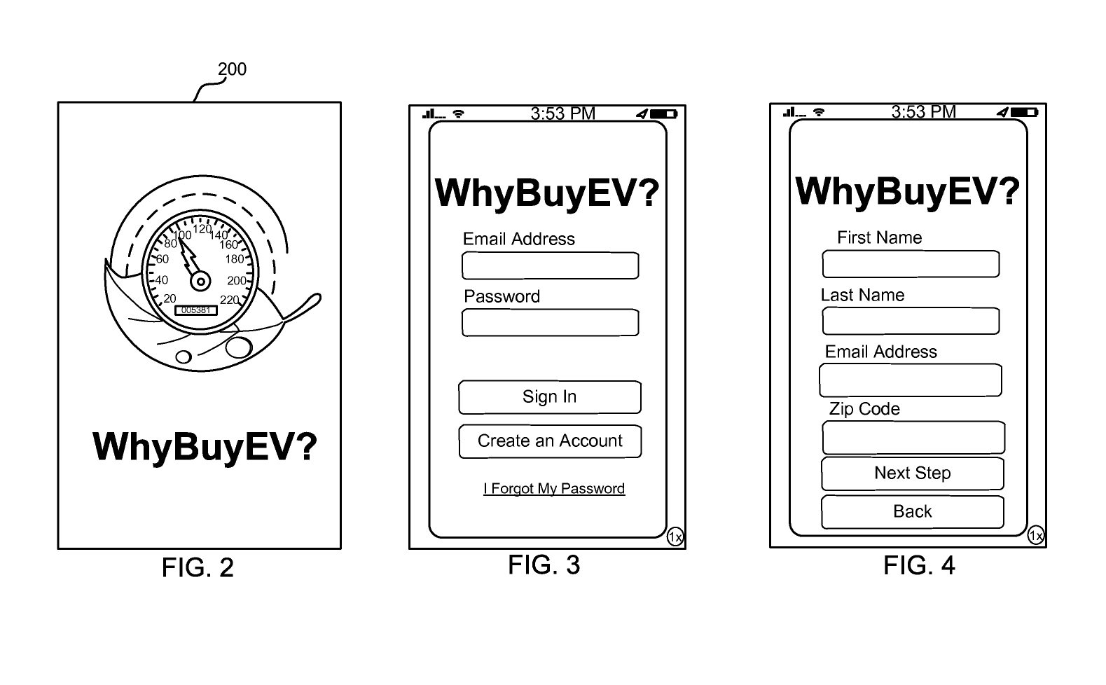

Referring now to FIGS. 2-26, there are shown exemplary screen shots of a graphical user interface (GUI) of a mobile device application (operative in the system of FIG. 1) that, in accordance with one particular preferred embodiment of the present invention, provides a system and method for recording driving patterns and suggesting purchasable vehicles implemented as a mobile device application. The application illustrated in FIGS. 2-26 permit a vehicle user to virtually test-drive an electric vehicle and/or plug-in hybrid vehicle, to determine the suitability of a particular electric/hybrid vehicle to the user's driving patterns and/or the suitability and cost efficiency, in general, of an electric or hybrid vehicle to the user. In particular, the application addresses the user desire's to purchase an electric or hybrid vehicle by simulating the electric or hybrid vehicle driving in the user's current vehicle, based on the user's driving habits and patterns.

If desired, the mobile device application can further be utilized for: evaluating the efficiency of the user's current electric vehicle and/or plug-in hybrid vehicle as compared to the electric vehicle and/or plug-in hybrid vehicle manufacturer's performance data; evaluating the user's current non-electric vehicle and/or plug-in hybrid vehicle driving with an electric vehicle and/or plug-in hybrid vehicle driving; evaluating other comparable electric vehicles and/or plug-in hybrid vehicles to the current electric vehicle and/or plug-in hybrid vehicle the user is driving; or evaluating other purchasable vehicles to the current vehicle the user is driving.

FIG. 2 is an example of an initial startup screen, such as an initial splash screen for an application or “app”, for use in connection with the present invention. The initial splash screen can include a logo and/or title. In the present example, the logo “WhyBuyEV” is displayed. Please note that “WhyBuyEV” is a trademark of Recharge Solutions International, and is not intended to be diluted or genericized by its use in connection with the present example.

Referring now to FIGS. 1-26, the splash screen 200 containing the logo and/or title can be displayed while the mobile device application is loading, connecting to the network and the application servers, and/or downloading the most recent EV car data models and uploading any driving data collected while the mobile device application may have been offline. This screen 200 can show briefly or for an extended amount of time depending on the performance of the mobile device 103, 105 and how quickly the mobile device 103, 105 can connect to the server 101 and/or network and retrieve the necessary data.

FIGS. 3 and 4 illustrate user profile creation/signup screens displayed on a screen of the mobile device 103, 105. The user profile creation/signup screens are made up of fillable GUI forms into which a user can input information and/or otherwise interact through the use of pulldown menus and softbuttons. In the user profile creation/signup screens, as shown in FIGS. 3 and 4, the user is prompted to create an account by entering identifying information, such as the user's first name, last name, email address and zip code. Once the user is logged in with the account they have created, the user can remain logged into the account so that the user need not sign in again on the mobile device application unless the user actively signs out.

FIG. 5 is one example of a Privacy Statement screen that can be displayed by the application of the present invention. The Privacy Statement screen can display an explanation of how driving data is detected, recorded, or otherwise collected and how the mobile device application uses the data collected. By selecting the “I Agree” option (i.e., by touching or otherwise selecting the “I Agree” softbutton), the user can accept the terms and progress to a User Agreement screen. By selecting “I Do Not Agree” option, the user can return to the user profile creation/signup screens (FIGS. 3 and 4) without saving any data.

FIG. 6 is one example of a User Agreement screen that can be displayed by the application of the present invention. The User Agreement screen can display the user agreement and terms of service for the mobile device application. By selecting the “I Agree” option or softbutton, the user can accept the terms and progress to a Create Password screen. By selecting the “I Do Not Agree” option, the user can return to the Privacy Statement screen (FIG. 5) without saving any data.

FIG. 7 illustrates one particular example of a password creation or “Create Password” screen. The Create Password screen can require the user to set a password of at least a predetermined number of characters (for example, six characters, or any other number of characters). The Create Password screen can also require that the password be entered twice correctly to be confirmed. If passwords do not match or do not meet the predetermined number of characters, an alert can be displayed.

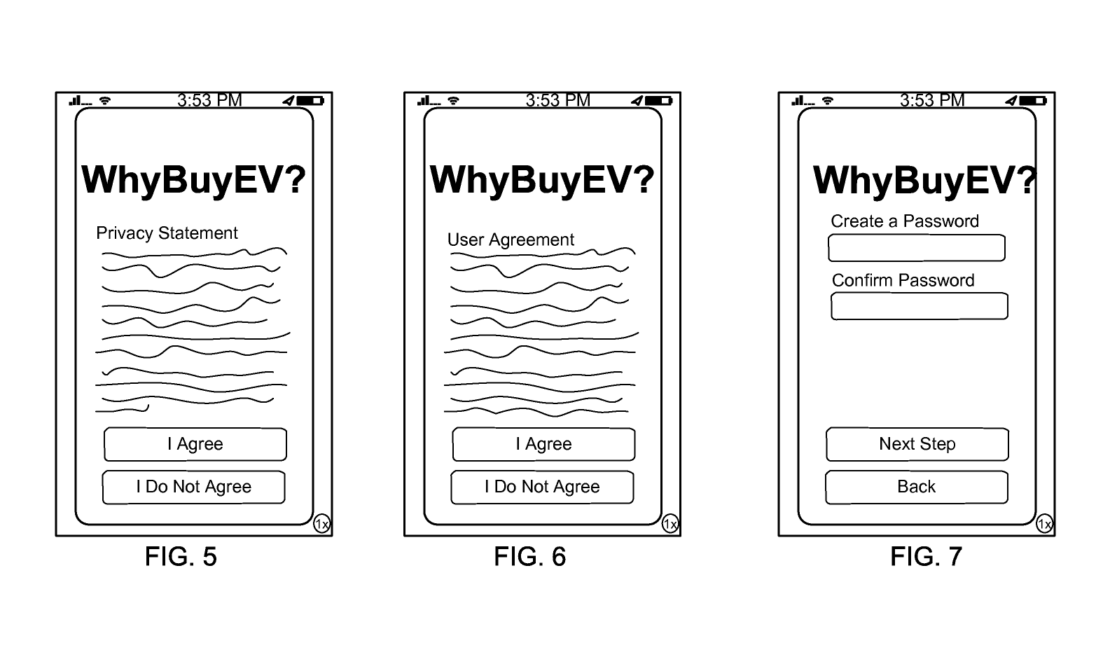

Once an account has been created and a password chosen, the user can then set up a vehicle profile using interactive GUI forms, represented by the exemplary GUI form shown in FIG. 8. More particularly, as shown in FIG. 8, the user can enter information about the user's current vehicle (i.e., the vehicle owned by the user, which may or may not be the vehicle used while executing the simulation). Once the user enters the particular information about the user's vehicle in the GUI form of FIG. 8, the mobile device application can obtain specific information and/or characteristics of that particular vehicle from a database for use in generating statistics relating to the user's own vehicle's driving statistics, carbon footprint, etc. For example, once the screen of FIG. 8 has been entered, the mobile device application can communicate with a server at one or more of 101, 109, 111 and/or 113, to pull down information about the particular make, year and/or model of car entered by the user. This information can be used to generate the driving statistics of the user's actual vehicle, as reported in the GUI form of FIG. 8, which will be used later to generate a driving profile of the user, in the user's existing car, which profile can be used to facilitate statistical comparisons between the user's present vehicle and suggested purchasable vehicles. For example, the information entered by a user regarding their current vehicle can be used, in combination with vehicle specification data for the current vehicle downloaded from the manufacturer and product information for that vehicle, to calculate information regarding the usage of the user's present vehicle, such as pollution emission, driving distances, types of driving, etc., that can be used to accurately determine potential savings, pollution reductions, etc. Additionally, the information can be used to suggest an EV and/or PHEV that is best suited to the driving profile generated for the user in the user's own vehicle, based on characteristics for that specific vehicle (i.e., downloaded from a database based on make, year and/or model). This provides a much greater accuracy than does a system that uses generalities to categorize the user's vehicle.

A Fuel & Electricity rates screen is illustrated in FIG. 9. In the Fuel & Electricity rates screen, the user can either set the rates to be determined automatically (i.e., the default) or can manually specify the cost per gallon of gasoline and/or the cost per kWh of electricity using drop down menus or fillable blanks in the GUI form of FIG. 9.

In one particular embodiment of the present invention, the application device can interact with social media outlets, such as Facebook™ and Twitter™. In FIG. 10, if desired, the user can be given the option of authenticating the mobile device application to post to their Facebook™ or Twitter™ accounts. The mobile device application can use the native API associated with the Facebook™ and Twitter™ services to make the connections with these services.

FIG. 11 is a Select Virtual EV screen. The Select a Virtual EV screen 210 can display images or a photos of selectable EV or PHEV purchasable vehicles. In the Select Virtual EV screen, the user can select one or more selectable EVs (i.e., the purchasable vehicles) to evaluate and compare to the user's current vehicle and driving habits. The mobile device application can load photos, categories, specifications and descriptions, and, if desired, the performance data model for each selected vehicle, from the mobile device application server 101, and/or from the manufacturers 109, the dealers 111 or even the Internet 113. or. In at least one embodiment, the mobile device application can provide two categories: EV and PHEV; however, those of ordinary skill in the art will appreciate that more than two categories can be provided and that other virtual vehicles, such as gasoline-powered vehicles, diesel vehicles, hybrid vehicles, or any other vehicle can be provided as the purchasable vehicles with which comparisons can be made. In at least one embodiment, the user can be required to select at least one EV (i.e., through the selection of a softbutton 220). In other embodiments, a virtual EV can be default-selected or automatically selected based at least in part on the user's profiles and the current vehicle of the user.

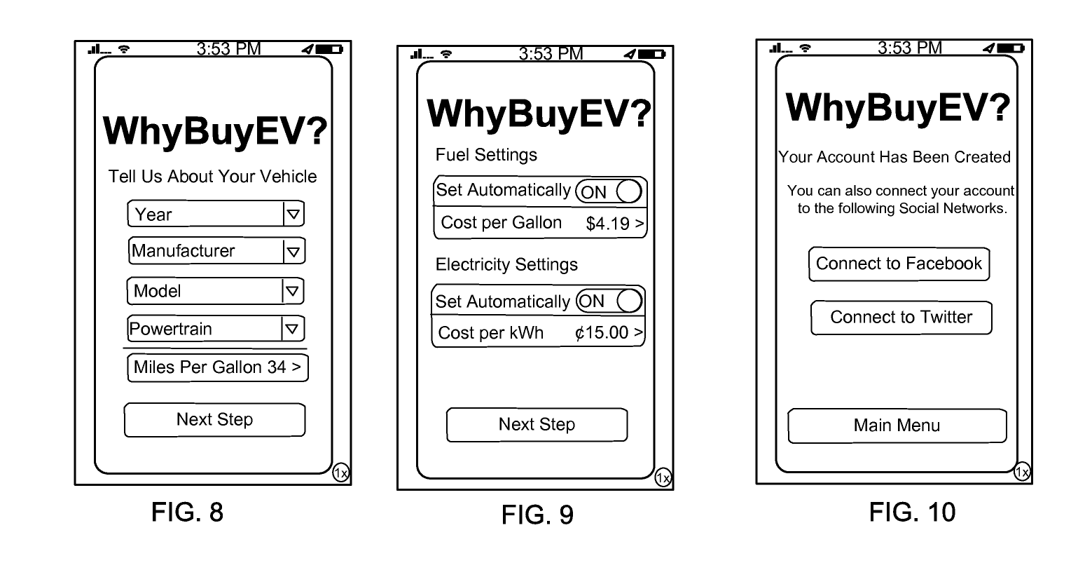

During the driving evaluation period, once the user is logged into the application on the mobile device 103, 105, the application can automatically start determining and recording driving data and determining driving patterns. For example, the application can automatically determine, through the use of sensors and the like, that the user is being transported in a vehicle (i.e., the speed of the mobile device 103, 105, as determined by its accelerometers or GPS sensors, exceeds a predetermined threshold). Information about the tracking of the driving data can be displayed on the display of the mobile device 103, 105, as shown in FIG. 12. If the mobile device application detects no extensive movement for more than a predetermined number of minutes (for example, five minutes), the mobile device application can pause recording or tracking the driving patterns and display this information to the user, as shown in FIG. 13. If vehicle movement resumes, the mobile device application can resume recording or tracking driving patterns with no user intervention. As can be seen from FIGS. 12 and 13, the user is informed as to the status of the data tracking. Note that the indicators are just that, indicators. They are not soft buttons pressed by the user to initiate or end tracking. In other words, in the present preferred embodiment of the invention, tracking starts and stops based on data received from at least one sensor of the mobile device 103, 105. In this way, the user need not manually initiate the data tracking, and thus cannot forget to initiate the data tracking. If desired however, the application can include software to override the automatic tracking feature, so that unusual trips (i.e., outlier events, such as plane trips, one time trips, etc.,) do not skew the data.

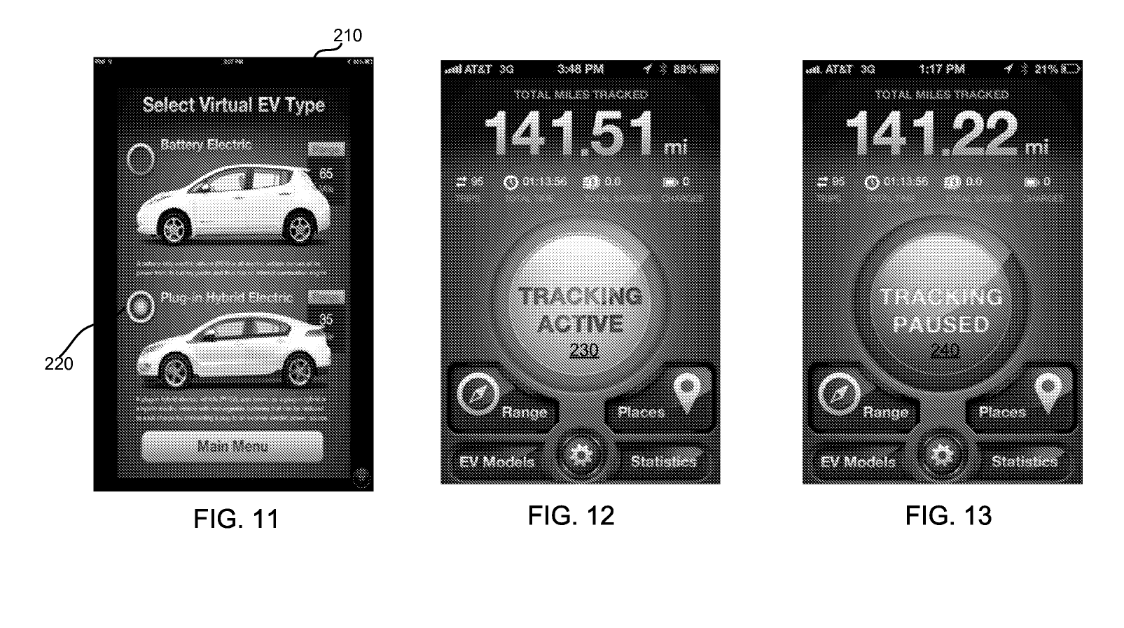

During the driving evaluation period, the user can view several range-related screens. As shown in FIG. 14, a Range Screen is accessible by selecting a “range” button 250 on the GUI display. (shown in FIG. 14) can display a map depicting the current range based on the selected EV/PHEV and the estimated battery life remaining. The user can use standard smartphone features (for example, the touch screen, an input-key, a trackpad, a trackball, cursor keys, or any other user input interface) to select a zoom level. The map can contain Range Circles, which indicate the remaining one way (second circle 259) and roundtrip (first circle 257) range based on the current selected Virtual EV. The range in the screen illustrated in FIG. 14 is centered on the current vehicle's position.

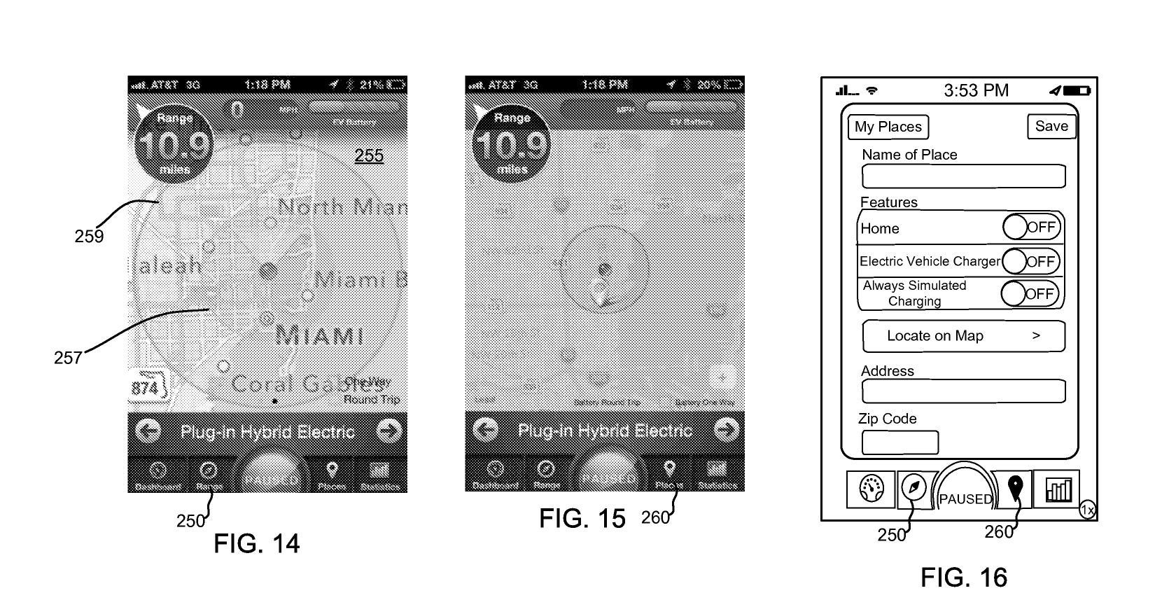

The My Places screen shown in FIG. 15 is selectable using the “places” button 260 on the GUI display. The My Places screen allows a user to visualize their current virtual EV/PHEV's range in relationship to places on the map that can be added by the user. The range is centered on the starting point or “Home”. For example, if the mobile device includes a touchscreen display, tapping on the touchscreen display corresponding to a place on the map can bring up an information tab that allows a user to see the distance to that point from their current location.

The Places Detail screen illustrated in FIG. 16 can allow a user to enter and/or display details about places or locations to which the user travels in a fillable GUI form on the display. For each place, the user can specify a place name, whether the place has an EV charger, whether charging should be simulated at this place, whether to locate on the Places map, and the place address, including zip code. In accordance with the present invention, the data entered into the fillable GUI forms described herein may be stored in memory on the mobile device 103, 105 and/or provided to the mobile device application server 101, the manufacturers 109, the dealers 111, and/or other users of the network 113, as desired.

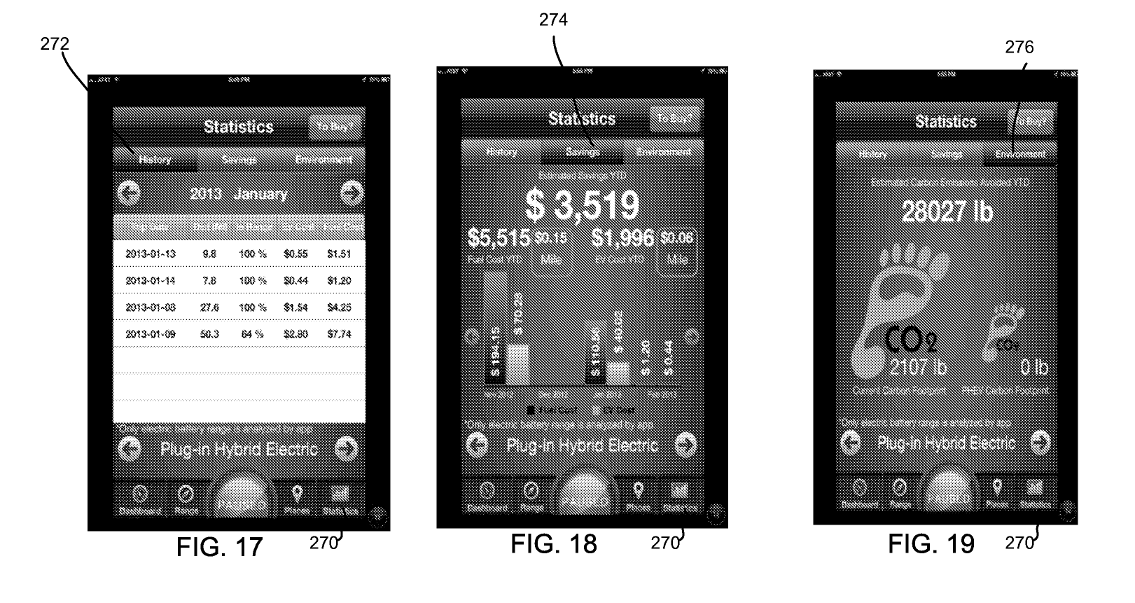

The GUI can also provide the user with a variety of statistical analyses through the selection of a statistics button 270 on the GUI display. For example, after the driving evaluation period (such as the test drive period) or at any time during the driving evaluation, a Statistics-History by Month screen, illustrated in FIG. 17, can be displayed by selecting a “history” tab 272 on the GUI display. While FIG. 17 illustrates a Statistics-History by Month, those of ordinary skill in the art will appreciate that the Statistics-History can be by any other predetermined period of time, such as a day, a week, a weekend, five-days, or any other predetermined period of time. The Statistics-History screen can provide an overview of current month trips arranged in chronological order. In at least one embodiment, additional months can be viewed by swiping left or right or using directional arrows displayed on the screen.

A Statistics-Savings screen as illustrated in FIG. 18 can be provided upon selection of a savings tab 274 on the GUI display under the statistics heading. The Statistics-Savings screen can provide a breakdown of the cost of fuel for the user's current vehicle and the cost of power consumed from the selected Virtual EV.

A Statistics-Environment screen as illustrated in FIG. 19 can be provided upon selection of an Environment tab 276 on the GUI display under the statistics heading. Selecting the Environment tab 276 can perform a calculation of the user's carbon footprint of the user's current vehicle and the estimated carbon footprint of the selected Virtual EV/PHEV.

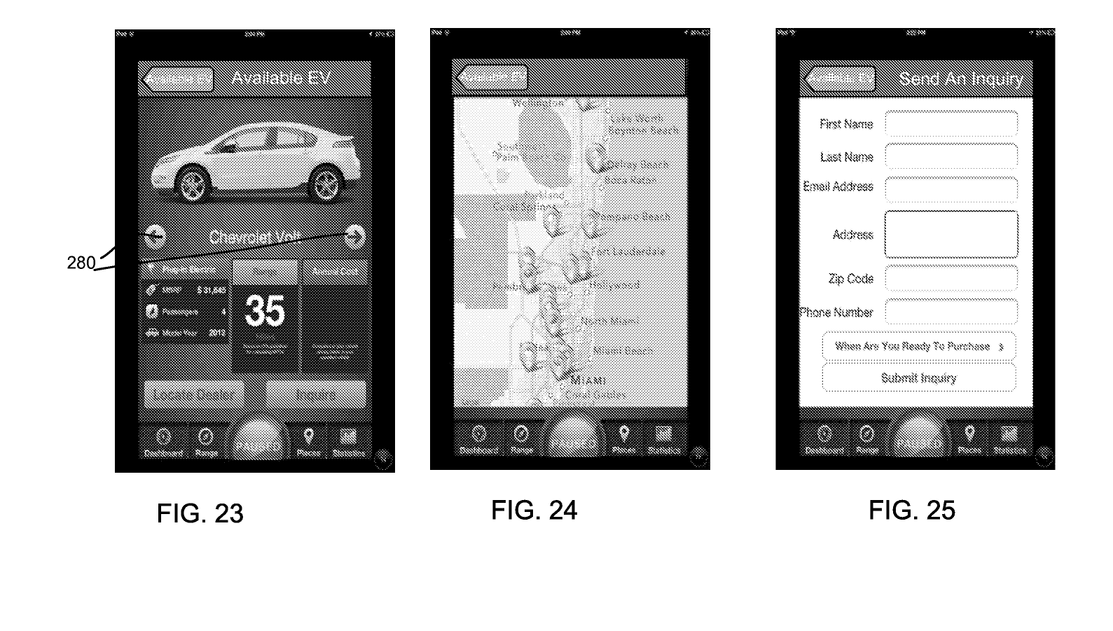

After the driving evaluation period is ended (for example, when the user has reached a destination), the user can view the Available EV screen shown in FIG. 22 to see a list of EVs that most closely match the user's driving habits and needs. The user can also select a user-selectable option to list only EVs, only PHEVs, or expand the view to all EVs and PHEVs. The determination of vehicles to recommend to the user can be generated at the mobile device 103, 105, using information from the systems 101, 109, 111 and/or 113, or may be generated at the systems 101, 109, 111 and/or 113 using driving data provided by the mobile device 103, 105, as desired.

If the user selects a particular EV, the Available EV Detail screen shown in FIG. 23 can be provided. In one particular embodiment of the invention, at least the information from which the EV Detail screen is generated is provided to the mobile device 103, 105 via the connectivity with the server 101 and/or the system units 109, 111 and/or 113. The Available EV Detail screen can include details associated with the selected EV. The Available EV Detail screen can also include a user-selectable option that allows the user to locate a dealer that sells the selected EV.

If the user chooses to locate a dealer, the dealers can be displayed in a map view. The Available EV Dealer Locations map view screen shown in FIG. 24 can display a map with dealerships that are within the user's geographic area (for example, by zip code, by a predetermined radius from the current location of the user's mobile device, or by any predetermined geographic area within the user's current or user-defined location).

If the user selects one of the local dealerships from the Local Dealerships map view screen (shown in FIG. 24), a pop-up window can be provided with the name and phone number of the selected dealership.

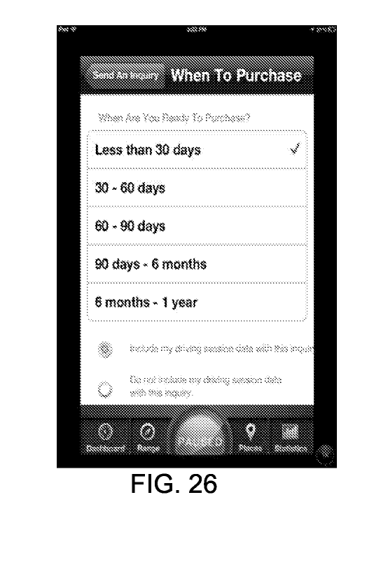

Additionally, if desired, the user can elect to send an inquiry, with or without the user's individual driving data, to a service, such as to WhyBuyEV, using the a Send an Inquiry screen illustrated in FIG. 25. The information which the user can provide can include a name, an email address, a mailing address, and a phone number. In at least one embodiment, the inquiry process can allow the user to select the When to Purchase Screen (shown in FIG. 26). The When to Purchase Screen can allow the user to select several pre-determined timeframes within which the user desires to purchase the selected EV. The When to Purchase Screen can also include an option to include or not include the driving session data with the inquiry. Once the user is ready to transmit the user's inquiry to Why Buy EV, the user can select the selectable option “Send an Inquiry” (shown in FIG. 25) to transmit the inquiry. In response to selecting the selectable option “Submit an Inquiry,” a confirmation screen can be displayed. The confirmation screen can display a confirmation “Inquiry Sent” message in response to the user's inquiry. In another embodiment, the inquiry process can allow a user to specify body style, price range, and/or any other particular specification regarding a vehicle.

In another embodiment, the inquiry can be sent directly to a dealer or manufacturer, In response to the selection of the one or more participating local purchasable vehicle dealers, the participating dealer(s) corresponding to the user's selection can receive an email, text message, automated voicemail, or any other message with relevant user information so that the participating dealer(s) can contact prospective buyer. In another embodiment, the user can make a mobile device appointment via the mobile device (for example, the smartphone). In another embodiment, the user can be immediately connected to the participating dealer by voice or video.

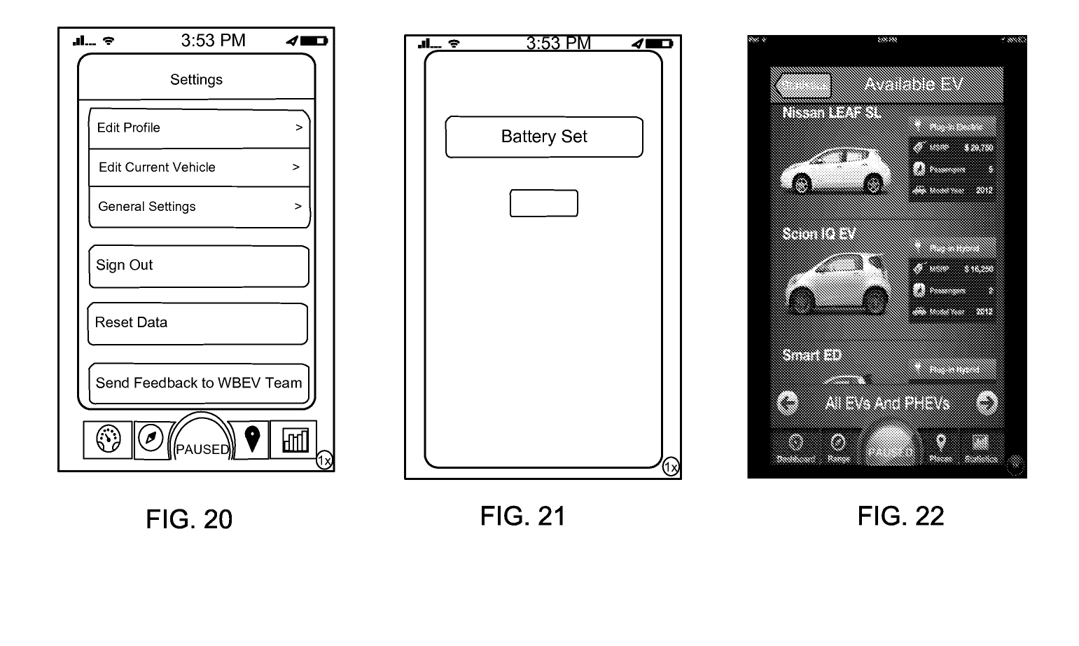

The mobile device application can also include a Settings menu, one exemplary version of which is illustrated in FIG. 20. Using the Settings menu, the user can personalize options and items associated with the mobile device application. The settings menu can include an Edit Profile option, an Edit Current Vehicle Option, a General Settings option, a Sign Out option, and a Reset Data option. Selecting the Units of Measure option can present an Edit Units of Measure screen, if desired. In the Edit Units of Measure screen, the user can change, for example, the units of measure for Distance, Temperature and Fuel (Volume) from imperial to metric units. Imperial can be selected by default, such that all data logged will be in Imperial units (miles, Fahrenheit and gallons). Metric conversions (kilometers, Celsius, and liters) can be made at the time of display of the value. Additionally, information can be set about the battery, as shown in FIG. 21.

The settings setting can additionally be used to change or update the Vehicle Profile entered as part of the sign-in process. In one particular embodiment of the invention, selection of the Vehicle Profile from the settings menu will return the user to a Vehicle Profile screen, such as is illustrated in FIG. 8, showing the primary or current vehicle profile. In the primary or current Vehicle Profile screen, the user can enter the make, model and year of the user's current vehicle. The mobile device application can load vehicle data associated with the user's current vehicle. For example, the vehicle data can be loaded from an online database that is maintained and updated frequently by the application server, from an internet source, from a manufacturer's database, from a vehicle dealer's database, or any other resource from which vehicle data can be retrieved.

Upon execution of the application on the mobile device 103, 105 (each time subsequent to the initial create a user/signup process), the application will display the splash screen of FIG. 2 while the application loads and initializes. The user may select a purchasable vehicle to simulate (as described in connection with FIG. 11) or the previously selected purchasable vehicle may be continued. After the selectable EV is selected, the user can begin driving, and the mobile device application can record the user's driving data that is indicative of the user's driving patterns and habits. This data can be stored in the mobile device 103, 105 and/or in the application server 101 or elsewhere in the system 100, as desired.

Based on the user's driving data, a map 255 can be displayed on the touchscreen display 103a of the mobile device 103, as illustrated in connection with FIG. 14. If desired, the map 255 can include a first circle (for example, a first circle 257) can be displayed on the map to indicate the area in which the selected EV can travel without requiring a battery charge. The map 255 can also include a second circle (for example, a second circle 259) to indicate the area in which the EV can travel one-way without requiring a battery charge. The first circle 257 and the second circle 259 can be centered about a current location of the user. In other embodiments, the first circle 257 and/or the second circle 259 can be centered about a home location of the user, a work location of the user, or any other predetermined or selected location of the user, as desired.

Additionally, as described herein in connection with FIG. 17, the mobile device application can provide statistics displays, illustrated in FIGS. 17-19, that provide the user with statistical information associated with the simulated electric-vehicle driving compared to the user's current vehicle driving. For example, as illustrated in FIG. 17, the Statistics display can include a compatibility value that indicates the compatibility of the user's current vehicle driving with similar driving habits using the selected EV. In other words, the compatibility value can be a percentage that the user's current vehicle driving can be satisfied by driving the selected EV, thereby providing the user with a suggestion that a selected EV can be more cost-effective or environmentally-cost-effective to drive instead of their current vehicles.

The Statistics displays of FIGS. 17-19 can also include, if desired, comparative data that compares at least one of a cost per mileage, a fuel versus recharge cost, a carbon footprint amount, an estimated annual fuel cost, or any other comparative data between the EV and the current vehicle the user drives that can assist the user in determining whether purchasing an EV (a PHEV or any other vehicle) is beneficial to him or her rather than continuing to drive his or her current vehicle.

The mobile device application can provide a Available EV display, as illustrated in FIGS. 22 and/or 23, that provides the user with information associated with a suggested purchasable vehicle based on the user's driving history. In FIG. 23, the application (or application server 101) recommended a Chevrolet Volt, based on the user's driving history data. The Available EV screen can also include vehicle specifications associated with the selectable EV. For example, the specifications can include a miles-per-charge, an annual cost, a manufacturer suggested retail price (MSRP), a city-driving mileage, a highway-driving mileage, or any other data associated with the selectable purchasable vehicle.

The Available EV screen of FIG. 23 can also include a selectable option which can be selected, actuated, or otherwise designated to indicate that the displayed selectable EV has been selected by the user. If the user desires to view another selectable EV, the user can select a scrolling arrows 280 that allow the user to traverse through a list, menu, or database of selectable EVs/PHEVs. For example, in FIG. 23, the scrolling arrows 280 can be a left arrow displayed to the left of the photo of the selectable EV and a right arrow displayed to the right to the photo of the selectable EV. In other embodiments, the scrolling arrows 280 can be up and down arrows. In still other embodiments, the available selectable EVs can be traversed or scrolled through by inputting left and right swiping motions across the touchscreen display 103a.

While the foregoing processes, description, and drawings have been described with respect to purchasable vehicles that are EVs and PHEVs, those of ordinary skill in the art will appreciate that the purchasable vehicle can be any other type of vehicle, such as a Sports Utility Vehicle (SUV), a hydrogen powered vehicle, a Flex-Fuel vehicle, a fuel-efficient gasoline-powered vehicle, an aerodynamically fuel-efficient gasoline-powered vehicle, or any other vehicle which a driver can purchase and for which a driving simulation can be simulated based on the user's current driving patterns of his or her current vehicle.

The present systems and methods of recording driving patterns and suggesting purchasable vehicles can be implemented to determine whether a particular leg or portion or which particular leg or portion of a driver's trip is better suited for a gasoline-powered vehicle, an EV, a PHEV, or any other purchasable vehicle.

The present systems and methods of recording driving patterns and suggesting purchasable vehicles can also be implemented to monitor and evaluate the current driving habits of a user to determine if the user is efficiently driving his or her current vehicle. For example, the system can record and evaluate the driver's driving patterns of his or her current vehicle and compare the driving pattern data to performance data (for example, performance data provided by the manufacturer of the driver's current vehicle) to determine if the driver is efficiently driving his or her current vehicle.

While the foregoing processes, description and drawings represent the preferred embodiments of the presently disclosed systems and methods for recording driving patterns and suggesting purchasable vehicles based at least in part on the recorded driving patterns, it will be understood that various changes and modifications may be made without departing from the scope of the present disclosure. Accordingly, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

We claim:

1. A method of providing information on purchasable vehicles, comprising the steps of:
determining, based on information entered into a mobile device, specific characteristics of a specific vehicle;
storing driving data obtained from at least one sensor of a mobile device while the specific vehicle carrying the mobile device is driving, the driving data including information relating to a driving pattern of the user-vehicle;
comparing performance data of at least one available vehicle with information based on the stored driving data of the specific vehicle; and
suggesting at least one vehicle for purchase based on a result of the comparing step.

2. The method of claim 1, wherein the at least one sensor includes at least one of a global positioning system (GPS) sensor, a barometer and an accelerometer.

3. The method of claim 2, further including the steps of:
determining, with a mobile device and without human intervention, that a vehicle carrying the mobile device has started driving; and
stopping the storage of driving data when the mobile device determines, without human intervention, that the vehicle carrying the mobile device has stopped driving.

4. The method of claim 3, wherein the determination of starting driving and/or stopping driving is made based on information from the at least one sensor.

5. The method of claim 4, wherein the determination of starting driving and/or stopping driving is made based on a predetermined change in an acceleration signal from an accelerometer of the mobile device.

6. The method of claim 4, wherein the determination of starting driving and/or stopping driving is made based on a predetermined rate of change in position reported by a GPS sensor of the mobile device.

7. The method of claim 1, further including the step of converting the driving data stored for the vehicle to simulated driving data relating to an attribute of the at least one available vehicle and wherein the comparing step compares the simulated driving data with vehicle specification data of the at least one available vehicle.

8. The method of claim 1, wherein the comparing step is performed remotely from the mobile device.

9. The method of claim 1, wherein, after the providing step information of a user of the mobile device is provided to a dealer or manufacturer of the at least one vehicle for purchase and/or the at least one available vehicle.

10. The method of claim 9, wherein the information of a user of the mobile device is provided to the dealer or manufacturer for a fee.

11. A mobile device including at least one sensor, the mobile device configured to:
obtain data specifications for a specific existing vehicle of a user based on information entered into said mobile device;
store driving data obtained from the at least one sensor after a determination that the vehicle has started driving until a determination that the vehicle has stopped driving;
generate, from said stored driving data and based on said data specifications, a driving profile for said specific existing vehicle; and
provide a list of available vehicles to a user via a graphical user interface of the mobile device, the list being generated based on said driving profile.

12. The mobile device of claim 11, wherein the at least one sensor includes at least one of a global positioning system (GPS) sensor, a barometer and an accelerometer.

13. The mobile device according to claim 11, wherein the list of available vehicles include at least one of electric vehicles, hybrid vehicles and plug-in hybrid vehicles.

14. The mobile device of claim 11, wherein the mobile device is additionally configured to:
automatically determine that a vehicle carrying the mobile device has started driving;
automatically determine that the vehicle carrying the mobile device has stopped driving; and
wherein the determination of starting driving and/or stopping driving is made based on information from the at least one sensor.

15. The mobile device of claim 14, wherein the determination of starting driving and/or stopping driving is made based on a predetermined change in an acceleration signal from an accelerometer of the mobile device.

16. The mobile device of claim 14, wherein the determination of starting driving and/or stopping driving is made based on a predetermined rate of change in position reported by a GPS sensor of the mobile device.

17. The mobile device of claim 11, wherein the mobile device is additionally configured to generate and display a carbon footprint of greenhouse gases and other pollutants for at least the specific existing vehicle and at least one of the vehicles or the at least one available vehicle based on the stored driving data.

18. A non-transitory storage medium including software that, when executed by a processor of a mobile device according to claim 11, performs the steps of:
storing driving data obtained from said at least one sensor after a determination that the vehicle has started driving until a determination that the vehicle has stopped driving; and
providing a list of available vehicles to a user via a graphical user interface of the mobile device, the list being generated based on said driving data.

19. A system, comprising:
a mobile device according to claim 11; and
at least one server configured to communicate with said mobile device.

20. The system of claim 19, wherein the stored driving data is transmitted to the at least one server and the list of available vehicles is generated from the at least one server based on the transmitted driving data and transmitted to the mobile device for display on the mobile device.

21. The system of claim 20, wherein the at least one server has access to a database containing data specifications for a plurality of available vehicles and compares information derived from said driving data to data specifications to generate the list of available vehicles.

22. The system of claim 21, wherein the plurality of available vehicles include at least one of electric vehicles, hybrid vehicles and plug-in hybrid vehicles.

23. The system of claim 19, wherein said at least one server provides the mobile device with access to at least one of a database of available vehicles of a manufacturer, or a dealer and/or from a website over the Internet.

24. The system of claim 20, wherein the driving data is stored in the mobile device when the mobile device is not in communication with the at least one server and transmitted to the at least one server when the mobile device is in communication with the at least one server.
